(19) United States
(12) Patent Application Publication
(10) Pub. No.: US 2022/0320512 A1
(43) Pub. Date: Oct. 6, 2022

(54) ALL SOLID STATE BATTERY

(71) Applicant: TOYOTA JIDOSHA KABUSHIKI KAISHA, Toyota-shi Aichi-ken (JP)

(72) Inventor: Akio Mitsui, Anjyo-shi Aichi-ken (JP)

(73) Assignee: TOYOTA JIDOSHA KABUSHIKI KAISHA, Toyota-shi Aichi-ken (JP)

(21) Appl. No.: 17/696,344

(22) Filed: Mar. 16, 2022

(30) Foreign Application Priority Data
Mar. 30, 2021 (JP) 2021-056741

(51) Int. Cl. H01M 4/58; H01M 10/0562; H01M 10/0525

(52) U.S. Cl. CPC H01M 4/5825; H01M 10/0562; H01M 10/0525; H01M 2004/027

(57) ABSTRACT

A main object of the present disclosure is to provide an all solid state battery with low battery resistance. The present disclosure achieves the object by providing an all solid state battery including a cathode layer, an anode layer, a solid electrolyte layer formed between the cathode layer and the anode layer; wherein the anode layer contains a lithium titanate that is an anode active material, and a solid electrolyte; a proportion of the anode active material with respect to a total of the anode active material and the solid electrolyte is 40 volume % or more and 80 volume % or less; and the anode layer does not contain a conductive material.

### CROSS-REFERENCE TO RELATED APPLICATIONS

This application is based upon and claims the benefit of priority of the prior Japanese Patent Application No. 2021-056741 filed Mar. 30, 2021, the entire contents of which are incorporated herein by reference.

### TECHNICAL FIELD

The present disclosure relates to an all solid state battery.

### BACKGROUND ART

An all solid state battery is a battery including a solid electrolyte layer between a cathode and an anode, and one of the advantages thereof is that the simplification of a safety device may be more easily achieved compared to a liquid-based battery including a liquid electrolyte containing a flammable organic solvent.

As an anode active material, lithium titanate has been known. For example, Patent Literature 1 discloses a battery using a lithium titanate that is an anode active material, a conductive material, and a solid non-aqueous electrolyte. Also, although it is not a technology related to an all solid state battery, for example, Patent Literature 2 discloses a non-aqueous battery using a conductive material that is produced by performing a high frequency treatment to a Li₄Ti₅O₁₂ sintered body.

### CITATION LIST

### Patent Literatures

Patent Literature 1: Japanese Patent Application Laid-Open (JP-A) No. 2008-243612

Patent Literature 2: JP-A No. 2012-009200

### SUMMARY OF DISCLOSURE

### Technical Problem

An all solid state batteries requires low battery resistance in order to have excellent output properties. The present disclosure has been made in view of the above circumstances and a main object thereof is to provide an all solid state battery with low battery resistance.

### Solution to Problem

In order to achieve the object, the present disclosure provides an all solid state battery including a cathode layer, an anode layer, a solid electrolyte layer formed between the cathode layer and the anode layer; wherein the anode layer contains a lithium titanate that is an anode active material, and a solid electrolyte; a proportion of the anode active material with respect to a total of the anode active material and the solid electrolyte is 40 volume % or more and 80 volume % or less; and the anode layer does not contain a conductive material.

According to the present disclosure, the anode layer containing the specified proportion of the lithium titanate, that is an anode active material, and a solid electrolyte, but not containing a conductive material allows an all solid state battery to have low resistance.

In the disclosure, the proportion may be 55 volume % or more and 70 volume % or less.

In the disclosure, the lithium titanate may be Li₄Ti₅O₁₂.

In the disclosure, the lithium titanate may be a material not subjected to a high frequency treatment.

In the disclosure, the solid electrolyte may be an inorganic solid electrolyte.

### Effects of Disclosure

The present disclosure exhibits an effect of providing an all solid state battery with low resistance.

### BRIEF DESCRIPTION OF DRAWINGS

FIG. 1 is a schematic cross-sectional view illustrating an example of the all solid state battery in the present disclosure.

### DESCRIPTION OF EMBODIMENTS

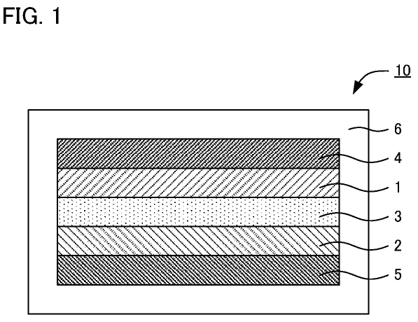

The all solid state battery in the present disclosure will be hereinafter explained in details. FIG. 1 is a schematic cross-sectional view illustrating an example of the all solid state battery in the present disclosure. All solid state battery 10 illustrated in FIG. 1 comprises cathode layer 1, anode layer 2, solid electrolyte layer 3 formed between the cathode layer 1 and the anode layer 2, cathode current collector 4 for collecting currents of the cathode layer 1, anode current collector 5 for collecting currents of the anode layer 2, and battery case 6 for storing these members. In the present disclosure, the anode layer 2 contains the specified proportion of lithium titanate that is an anode active material, and a solid electrolyte. Also, the anode layer 2 does not contain a conductive material.

According to the present disclosure, the anode layer containing the specified proportion of the lithium titanate, that is an anode active material, and a solid electrolyte, but not containing a conductive material allows an all solid state battery to have low resistance.

As described above, Patent Literature 1 discloses a battery using a lithium titanate that is an anode active material, a conductive material, and a solid non-aqueous electrolyte such as a polymer electrolyte. A conductive material is a material useful to give excellent electron conductivity to an electrode layer. However, in an all solid state battery with an electrolyte not having fluidity, the conductive material may interfere the contact between the active material and the solid electrolyte, and thereby there is a risk of increasing the battery resistance.

On the other hand, in the present disclosure, the anode layer contains the specified proportion of lithium titanate that is an anode active material, and a solid electrolyte. For this reason, the lithium titanate itself can take a role of the electron conductivity inside the anode layer, and thus addition of a conductive material is not necessary. Also, since the contact between the anode active material and the solid electrolyte is not interfered by a conductive material, decrease of ion conductivity can also be suppressed. As a result, in the present disclosure, an all solid state battery may have low resistance and excellent output properties. Also, in the present disclosure, the anode layer does not need to include a conductive material, and thus the proportion of the anode active material may be relatively increased. As a result, there is also an advantage that the volume energy density will be excellent.

Incidentally, in the liquid-based battery of Patent Literature 2, as the anode active material and the conductive material, lithium titanate subjected to a high frequency treatment is used. However, in such a lithium titanate subjected to the treatment, for example, dispersibility to a dispersion medium such as butyl butyrate used in the production of all solid state battery, is considered to be degraded. High frequency may electrify the surface of particle, but it is presumed that there is a possibility that electrification decomposes the dispersion medium such as butyl butyrate. When the reaction of decomposing the dispersion medium occurs, particles are aggregated so as to minimize the contact between particles (particles of lithium titanate) and the dispersion medium inside the slurry, and as a result, the dispersibility is considered to be degraded. Also, the decomposition of butyl butyrate may cause foam, and in that case, the force of kneading is not easily applied to the lithium titanate itself, and as a result, the dispersibility is considered to be degraded. For this reason, it is difficult to apply the disclosure of Patent Literature 2 as it is to an all solid state battery.

1. Anode Layer

The anode layer in the present disclosure contains a lithium titanate that is an anode active material, and a solid electrolyte. The lithium titanate exhibits excellent electron conductivity when Li is intercalated upon charge. In some embodiments, the electron conductivity (25° C.) of the lithium titanate when Li is intercalated is, for example, 8.0*10⁻¹ S/cm or more. Meanwhile, the solid electrolyte is usually a material not having electron conductivity. The electron conductivity (25° C.) of the solid electrolyte is, for example, 10⁻⁶ S/cm or less, may be 10⁻⁸ S/cm or less, and may be 10⁻¹⁰ S/cm or less. Also, the anode layer in the present disclosure usually does not contain a conductive material. “Conductive material” here refers to a material having higher electron conductivity than that of the lithium titanate (electron conductivity of the lithium titanate when Li is intercalated, to be exact). The material having the highest electron conductivity in the anode layer is, usually the lithium titanate.

The anode active material in the present disclosure is a lithium titanate. The lithium titanate is a compound containing at least a Li element, a Ti element, and an O element. Also, at least one of the Li element and the Ti element may be partially substituted with other element. Examples of the lithium titanate may include Li₂TiO₃, Li₄Ti₅O₁₂, and Li₂Ti₂O₅. In some embodiments, Li₄Ti₅O₁₂ is used. In some embodiments, the lithium titanate is a material not subjected to the high frequency treatment. Examples of the high frequency treatment may include the treatment described in Patent Literature 2.

Examples of the shape of the anode active material may include a granular shape. The average particle size (D₅₀) of the anode active material is, for example, 10 nm or more, and may be 100 nm or more. Meanwhile, the average particle size (D₅₀) of the anode active material is, for example, 50 μm or less, and may be 20 μm or less. The average particle size (D₅₀) may be calculated from, for example, a measurement with a laser diffraction particle distribution meter or a scanning electron microscope (SEM).

In some embodiments, the solid electrolyte is an inorganic solid electrolyte. Examples of the inorganic solid electrolyte may include a sulfide solid electrolyte, an oxide solid electrolyte, a nitride solid electrolyte, and a halide solid electrolyte. In some embodiments, the sulfide solid electrolyte is used.

In some embodiments, sulfide solid electrolyte includes a Li element, an A element (A is at least one kind of P, Ge, Si, Sn, B and Al), and a S element. The sulfide solid electrolyte may further include a halogen element. Examples of the halogen element may include a F element, a Cl element, a Br element, and an I element. Also, the sulfide solid electrolyte may further contain an O element.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m, n is a positive number; Z is any one of Ge, Zn, and Ga), Li₂S—GeS₂, Li₂S—SiS₂—Li₃PO₄, and Li₂S—SiS₂—LiₓMO_{y} (provided that x, y is a positive number; M is any one of P, Si, Ge, B, Al, Ga, and In).

The solid electrolyte may be glass, and may have a crystal phase. Examples of the shape of the solid electrolyte may include a granular shape. The average particle size (D₅₀) of the solid electrolyte is, for example, 0.01 μm or more. Meanwhile, the average particle size (D₅₀) of the solid electrolyte is, for example, 10 μm or less, and may be 5 μm or less. The ion conductivity of the solid electrolyte at 25° C. is, for example, 1*10⁻⁴ S/cm or more, and may be 1*10⁻³ S/cm or more.

Also, in the anode layer, the proportion of the anode active material with respect to the total of the anode active material and the solid electrolyte is in the specified range. The proportion is, usually 40 volume % or more, may be 50 volume % or more, and may be 60 volume % or more. When the proportion of the anode active material is too small, sufficient electron conductivity cannot be given to the anode layer, and the resistance tends to increase. Also, when the amount of the anode active material is little, the volume energy density is easily degraded. Meanwhile, the proportion is usually 80 volume % or less and may be 70 volume % or less. When the proportion of the anode active material is too large, sufficient ion conductivity cannot be given to the anode layer, and the resistance tends to increase.

In some embodiments, the content of the anode active material in the anode layer is larger from the viewpoint of capacity; for example, it is 30 volume % or more, may be 50 volume % or more, and may be 60 volume % or more. Also, the content of the solid electrolyte in the anode layer is, for example, 10 volume % or more and 60 volume % or less, and may be 15 volume % or more and 55 volume % or less.

Also, the anode layer may contain a binder as required. There are no particular limitations on the binder if it is chemically and electronically stable, and examples of the binder may include a fluorine-based binder such as polyvinylidene fluoride (PVDF) and polytetra fluoroethylene (PTFE), and a rubber-based binder such as acrylate butadiene rubber (ABR) and styrene butadiene rubber (SBR). The content of the binder in the anode layer is, for example, 10 volume % or more and 20 volume % or less. Also, the thickness of the anode layer is, for example, 0.1 μm or more and 1000 μm or less.

2. Cathode Layer

The cathode layer contains at least a cathode active material, and may contain at least one of a conductive material, a binder and a solid electrolyte, as required. Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂ and Li(Ni_{0.5}Mn_{1.5})O₄; and an olivine type active material such as LiFePO₄, LiMnPO₄, LiNiPO₄, and LiCoPO₄. The surface of the cathode active material may be coated with an ion conductive oxide. Examples of the ion conductive oxide may include LiNbO₃.

The proportion of the cathode active material in the cathode layer is, for example, 20 weight % or more, may be 30 weight % or more and may be 40 weight % or more. Meanwhile, the proportion of the cathode active material is, for example, 80 weight % or less, may be 70 weight % or less and may be 60 weight % or less.

Examples of the conductive material may include a carbon material. Specific examples of the carbon material may include acetylene black, Ketjen black, VGCF, and graphite. The binder and the solid electrolyte are in the same contents as those described in “1. Anode layer”; thus, the descriptions herein are omitted. Also, the thickness of the cathode layer is, for example, 0.1 μm or more and 1000 μm or less.

3. Solid Electrolyte Layer

The solid electrolyte layer is a layer formed between the cathode layer and the anode layer, and contains at least a solid electrolyte. Also, the solid electrolyte layer may further contain a binder. The solid electrolyte and the binder are in the same contents as those described in “1. Anode layer”; thus, the descriptions herein are omitted. The thickness of the solid electrolyte layer is, for example, 0.1 μm or more and 1000 μm or less.

4. Other Constitutions

In some embodiments, the all solid state battery in the present disclosure comprises a cathode current collector for collecting currents of the cathode layer, an anode current collector for collecting currents of the anode layer and a battery case for storing the above described members. Examples of the shape of the current collectors may include a foil shape, a mesh shape, and a porous shape. Also, as the battery case, conventionally known battery cases may be used.

5. All Solid State Battery

Also, the all solid state battery in the present disclosure may further include a restraining jig that applies a restraining pressure along with the thickness direction of the cathode current collector, the cathode layer, the solid electrolyte layer, the anode layer and the anode current collector. As the restraining jig, known jigs may be used. The restraining pressure is, for example, 0.1 MPa or more and may be 1 MPa or more. Meanwhile, the restraining pressure is, for example, 50 MPa or less, and may be 20 MPa or less.

The kind of the all solid state battery in the present disclosure is not particularly limited, but is typically a lithium ion battery. Also, the all solid state battery in the present disclosure may be a primary battery and may be a secondary battery, but in some embodiments, the all solid state battery is a secondary battery among them. The reason therefor is to be repeatedly charged and discharged and useful as a car-mounted battery for example.

The all solid state battery in the present disclosure may be a single battery and may be a layered battery. The layered battery may be a monopolar layered battery (layered battery connected in parallel), and may be a bipolar layered battery (layered battery connected in series). Examples of the shape of the battery may include a coin shape, a laminate shape, a cylindrical shape and a square shape.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Anode Mixture>

An anode active material (Li₄Ti₅O₁₂ particle: density 3.5 g/cc, average primary particle diameter 0.7 μm) and a binder (PVdF: density 0.9 g/cc) were weighed so as to be the volume ratio in Table 1, and added to 1.6 g of a dispersion medium (butyl butyrate). The mixture was mixed for 30 minutes using an ultrasonic homogenizer (UH-50 from SMT Corporation) to obtain slurry. To the obtained slurry, a sulfide solid electrolyte (LiI—LiBr—Li₂S—P₂S₅-based glass ceramic: density 2 g/cc) was added, and mixed again for 30 minutes using an ultrasonic homogenizer (UH-50 from SMT Corporation). Thereby, an anode mixture was obtained.

<Production of Cathode Mixture>

As a cathode active material, LiNi_{1/3}Co_{1/3}Mn_{1/3}O₂ subjected to the surface treatment with LiNbO₃ was used. Weighed were 2.0 g of this cathode active material, 0.048 g of a conductive material (VGCF), 0.407 g of a sulfide solid electrolyte (LiI—LiBr—Li₂S—P₂S₅-based glass ceramic: density 2 g/cc), 0.016 g of a binder (PVdF) and 1.3 g of a dispersion medium (butyl butyrate). These were mixed using an ultrasonic homogenizer (UH-50 from SMT Corporation). Thereby, a cathode mixture was obtained.

<Production of Mixture for Solid Electrolyte Layer>

A dispersion medium (heptane), a binder (heptane solution including 5 mass % of butadiene rubber-based binder), and a sulfide solid electrolyte (LiI—LiBr—Li₂S—P₂S₅-based glass ceramic: average primary particle diameter 2.5 μm) were added to a container made of polypropylene, and mixed for 30 seconds using an ultrasonic homogenizer (UH-50 from SMT Corporation). Next, the container was shaken for 3 minutes by a shaker. Thereby, a mixture for solid electrolyte layer was obtained.

<Production of all Solid Lithium Ion Secondary Battery>

The cathode mixture was pasted on an aluminum foil by a blade method using an applicator. After the pasting, the product was dried for 30 minutes on a hot plate at 100° C. Thereby, a cathode including a cathode layer on the surface of the aluminum foil was obtained. In the same manner, the anode mixture paste was pasted on an anode current collector and dried to obtain an anode including an anode layer. Incidentally, anode weight was adjusted so that the anode charge specific capacity became 1.15 times when the cathode charge specific capacity was 185 mAh/g.

The cathode was pressed in advance. To the surface of the cathode layer already pressed, the mixture for a solid electrolyte layer was pasted by a dye coater, and dried for 30 minutes on a hot plate at 100° C. After that, the product was roll-pressed at 2 ton/cm². Thereby, a cathode side layered body including a solid electrolyte layer on the surface of the cathode layer was obtained. Also, the anode was pressed in advance. To the surface of the anode layer already pressed, the mixture for a solid electrolyte layer was pasted by a dye coater, and dried for 30 minutes on a hot plate at 100° C. After that, the product was roll-pressed at 2 ton/cm². Thereby, an anode side layered body including a solid electrolyte layer on the surface of the anode layer was obtained.

The cathode side layered body and the anode side layered body were respectively punched out, and stacked so that the solid electrolyte layers of the both were stuck together. Here, the both were stuck together with non-pressed solid electrolyte layer (mixture for a solid electrolyte layer) transferred between the solid electrolyte layer of the cathode side layered body and the solid electrolyte layer of the anode side layered body. After that, the product was pressed at 130° C. and 2 ton/cm², so as to obtain a power generating element including constituents in the order of the cathode, the solid electrolyte layer, and the anode. The obtained power generating element was sealed by laminate and restrained at 5 MPa so as to produce an all solid lithium ion secondary battery for evaluation.

### Examples 2 to 9 and Comparative Examples 1 to 11

An all solid lithium ion secondary battery was produced in the same manner as in Example 1 except that the composition of the anode layer was changed as in Table 1. Incidentally, when a conductive material was used in the anode mixture, a carbon material (VGCF: density 2 g/cc) was used.

### Evaluation

<Direct Current Resistance Measurement>

First, initial charge and discharge were conducted to the lithium ion secondary batteries produced in Examples 1 to 9 and Comparative Examples 1 to 11, in the following conditions. For the initial charge, the batteries were constant current charged at the current equivalent to 1 C, and when the cell voltage reached at 2.95 V, constant voltage charged, then when the charge current reached at the current equivalent to 0.01 C, the initial charge was terminated. For the initial discharge, the batteries were constant current discharged at the current equivalent to 1 C, and the discharge was terminated when reached at 1.5 V.

Each battery after the initial charge and discharge was constant current charged at the current equivalent to 3 C. Then, the direct current resistance was calculated by dividing the difference of the voltage before charge and the voltage after charge for 10 seconds, by the current equivalent to 3 C. The results are shown in Table 1.

TABLE 1

| | | | | | Proportion of active | | |
|---|---|---|---|---|---|---|---|
| | | | | | material and solid | | |
| | Composition of anode layer (vol %) | | | | electrolyte (Vol %) | | Charge |
| | Active | Solid | | Conductive | Active | Solid | resistance |
| | material | electrolyte | Binder | material | material | electrolyte | (Ω/cm²) |
| Comp. Ex. 1 | 23.2 | 69.8 | 7.0 | 0.0 | 25 | 75 | 53.9 |
| Comp. Ex. 2 | 23.0 | 68.9 | 6.9 | 1.2 | 25 | 75 | 35.5 |
| Comp. Ex. 3 | 27.5 | 64.2 | 8.3 | 0.0 | 30 | 70 | 47.6 |
| Comp. Ex. 4 | 27.2 | 63.6 | 8.2 | 1.0 | 30 | 70 | 30.8 |
| Comp. Ex. 5 | 31.7 | 58.9 | 9.4 | 0.0 | 35 | 65 | 42.3 |
| Comp. Ex. 6 | 31.5 | 58.5 | 9.4 | 0.6 | 35 | 65 | 27.5 |
| Example 1 | 35.7 | 53.5 | 10.8 | 0.0 | 40 | 60 | 20.9 |
| Example 2 | 39.6 | 48.4 | 12.0 | 0.0 | 45 | 55 | 19.6 |
| Example 3 | 43.4 | 43.5 | 13.1 | 0.0 | 50 | 50 | 19.1 |
| Example 4 | 47.2 | 38.6 | 14.2 | 0.0 | 55 | 45 | 18.3 |
| Example 5 | 50.8 | 33.9 | 15.3 | 0.0 | 60 | 40 | 18.5 |
| Example 6 | 54.4 | 29.3 | 16.3 | 0.0 | 65 | 35 | 18.1 |
| Example 7 | 57.8 | 24.8 | 17.4 | 0.0 | 70 | 30 | 18.4 |
| Example 8 | 61.2 | 20.4 | 18.4 | 0.0 | 75 | 25 | 18.9 |
| Example 9 | 64.5 | 16.1 | 19.4 | 0.0 | 80 | 20 | 19.2 |
| Comp. Ex. 7 | 35.6 | 53.4 | 10.7 | 0.3 | 40 | 60 | 24.8 |
| Comp. Ex. 8 | 43.3 | 43.3 | 13.0 | 0.4 | 50 | 50 | 27.3 |
| Comp. Ex. 9 | 50.6 | 33.7 | 15.2 | 0.5 | 60 | 40 | 29.0 |
| Comp. Ex. 10 | 57.5 | 24.7 | 17.3 | 0.5 | 70 | 30 | 33.1 |
| Comp. Ex. 11 | 64.1 | 16.0 | 19.3 | 0.6 | 80 | 20 | 35.4 |

As shown in Table 1, the resistance of Examples 1 to 9 was respectively lower than that of Comparative Examples 1 to 11, and the batteries had excellent output properties. This is presumably because excellent electron conductivity and ion conductivity were exhibited in the anode layer of Examples 1 to 9. Also, although the charge resistance of Comparative Examples 2, 4, and 6 was respectively lower than that of Comparative Examples 1, 3, and 5, the charge resistance was respectively higher than that of Examples. It is presumed that although the electron conductivity improved by the addition of the carbon material, the contact between the active material and the solid electrolyte was interfered to degrade the ion conductivity. Similarly, from the results of Examples 1, 3, 5, 7 and 9, and Comparative Examples 7 to 11, it was confirmed that the resistance increased when the carbon material was added.

### REFERENCE SIGNS LIST

1 cathode layer
2 anode layer
3 solid electrolyte layer
4 cathode current collector
5 anode current collector
6 battery case
10 all solid state battery

What is claimed is:

1. An all solid state battery comprising a cathode layer, an anode layer, a solid electrolyte layer formed between the cathode layer and the anode layer; wherein
the anode layer contains a lithium titanate that is an anode active material, and a solid electrolyte;
a proportion of the anode active material with respect to a total of the anode active material and the solid electrolyte is 40 volume % or more and 80 volume % or less; and
the anode layer does not contain a conductive material.

2. The all solid state battery according to claim 1, wherein the proportion of the anode active material is 55 volume % or more and 70 volume % or less.

3. The all solid state battery according to claim 1, wherein the lithium titanate is Li₄Ti₅O₁₂.

4. The all solid state battery according to claim 1, wherein the lithium titanate is a material not subjected to a high frequency treatment.

5. The all solid state battery according to claim 1, wherein the solid electrolyte is an inorganic solid electrolyte.
